(19) United States
(12) Patent Application Publication
(10) Pub. No.: US 2024/0208245 A1
(43) Pub. Date: Jun. 27, 2024

(54) PRINTING DEVICE AND PRINTING METHOD

(71) Applicant: SEIKO EPSON CORPORATION, Tokyo (JP)

(72) Inventors: Hiroshi TOYAMA, SHIOJIRI-SHI (JP); Satoru KATAGAMI, MATSUMOTO-SHI (JP); Yuichi WASHIO, SHIOJIRI-SHI (JP); Kazutoshi FUJISAWA, OKAYA-SHI (JP); Ko TAKANASHI, MATSUMOTO-SHI (JP)

(21) Appl. No.: 18/545,422

(22) Filed: Dec. 19, 2023

(30) Foreign Application Priority Data
Dec. 23, 2022 (JP) 2022-207259

(51) Int. Cl. B41J 11/00

(52) U.S. Cl. CPC B41J 11/0022

(57) ABSTRACT

A printing apparatus includes a setting unit, a winding unit, a printing head and a drying oven, and the drying oven includes a blower heating unit and a contact heating unit. The printing apparatus includes a first mode and a second mode as printing modes. Either a temperature of the gas blown by the blower heating unit in the second mode is lower than a temperature of the gas blown by the blower heating unit in the first mode or a heating temperature of the contact heating unit in the second mode is lower than a heating temperature of the contact heating unit in the first mode or both. A wind velocity of the gas blown by the blower heating unit in the second mode is higher than a wind velocity of the gas blown by the blower heating unit in the first mode.

The present application is based on, and claims priority from JP Application Serial Number 2022-207259, filed Dec. 23, 2022, the disclosure of which is hereby incorporated by reference herein in its entirety.

### BACKGROUND

### 1. Technical Field

The present disclosure relates to a printing apparatus and a printing method.

### 2. Related Art

In the related art, various printing apparatuses that perform printing by ejecting ink to a printing medium are used. Such printing apparatuses include printing apparatuses that include a heating unit that heats the printing medium and can dry the ink ejected to the printing medium. For example, JP-A-2020-199660 discloses a printing apparatus including a heating unit that heats the back surface of the printing medium. In addition, for example, JP-A-2018-130900 discloses a printing apparatus including a drying unit (heating unit) that performs heating by blowing hot air to the surface of the medium (printing medium).

Various printing mediums are used. For example, in some cases label sheets of which the image formation surface of the printing medium is made of a film and the opposite surface opposite to the image formation surface is made of paper, and the like are used as the printing medium. For example, in some cases, in the case of a printing medium, such as a label sheet, of which the image formation surface and the opposite surface are made of different materials, the condition of the printing medium may change in such a manner that a part of the image formation surface is separated from the member of the opposite surface depending on the heating method of the heating unit, for example. In particular, in the case of a label sheet of which the image formation surface of the printing medium is made of a film and the opposite surface opposite to the image formation surface is made of paper, a part of the image formation surface may be separated from the opposite surface with the film stretched and the paper shrunk if the heating temperature of the printing medium is excessively high, for example.

### SUMMARY

A printing apparatus according to an aspect of the present disclosure for solving the above-mentioned problems includes a setting unit at which a printing medium with a roll form is to be set, a winding unit configured to wind up the printing medium conveyed from the setting unit, a printing head configured to form an image by ejecting ink to an image formation surface of the printing medium conveyed, and a drying oven disposed downstream of the printing head in a conveyance path of the printing medium in a conveyance direction of the printing medium, the drying oven being configured to dry the ink ejected to the printing medium, wherein the drying oven includes a heating unit configured to heat the printing medium, the heating unit includes a blower heating unit configured to blow a gas being a heated gas to the image formation surface, and a contact heating unit configured to heat the printing medium by coming into contact with a surface on a side opposite to the image formation surface of the printing medium, the printing apparatus includes a first mode and a second mode as printing modes for forming the image on the printing medium, either a temperature of the gas blown by the blower heating unit in the second mode is lower than a temperature of the gas blown by the blower heating unit in the first mode or a heating temperature of the contact heating unit in the second mode is lower than a heating temperature of the contact heating unit in the first mode or both, and a wind velocity of the gas blown by the blower heating unit in the second mode is higher than a wind velocity of the gas blown by the blower heating unit in the first mode.

Another printing apparatus according to an aspect of the present disclosure for solving the above-mentioned problems includes a setting unit at which a printing medium with a roll form is to be set, a winding unit configured to wind up the printing medium conveyed from the setting unit, a printing head configured to form an image by ejecting ink to an image formation surface of the printing medium conveyed, and a drying oven disposed downstream of the printing head in a conveyance path of the printing medium in a conveyance direction of the printing medium, the drying oven being configured to dry the ink ejected to the printing medium, wherein the drying oven includes a heating unit configured to heat the printing medium, the heating unit includes a blower heating unit configured to blow a gas being a heated gas to the image formation surface, and a contact heating unit configured to heat the printing medium by coming into contact with a surface on a side opposite to the image formation surface of the printing medium, the contact heating unit includes a first contact heating unit, and a second contact heating unit disposed downstream of the first contact heating unit in the conveyance direction, the blower heating unit includes a first blower heating unit, and a second blower heating unit disposed downstream of the first blower heating unit in the conveyance direction, the printing apparatus includes a first mode and a second mode as printing modes for forming the image on the printing medium, a heating temperature of the first contact heating unit in the second mode is lower than a heating temperature of the first contact heating unit in the first mode, a heating temperature of the second contact heating unit in the second mode is lower than a heating temperature of the second contact heating unit in the first mode, a temperature of the gas blown by the first blower heating unit in the second mode is lower than a temperature of the gas blown by the first blower heating unit in the first mode, a temperature of the gas blown by the second blower heating unit in the second mode is lower than a temperature of the gas blown by the second blower heating unit in the first mode, a wind velocity of the gas blown by the first blower heating unit in the second mode is higher than a wind velocity of the gas blown by the first blower heating unit in the first mode, and a wind velocity of the gas blown by the second blower heating unit in the second mode is higher than a wind velocity of the gas blown by the second blower heating unit in the first mode.

A printing method according to an aspect of the present disclosure for solving the above-mentioned problems is a printing method for a printing apparatus, the printing apparatus including a setting unit at which a printing medium with a roll form is to be set, a winding unit configured to wind up the printing medium conveyed from the setting unit, a printing head configured to form an image by ejecting ink to an image formation surface of the printing medium conveyed, and a drying oven disposed downstream of the printing head in a conveyance path of the printing medium in a conveyance direction of the printing medium, the drying oven being configured to dry the ink ejected to the printing medium, the drying oven including a heating unit configured to heat the printing medium, the heating unit including a blower heating unit configured to blow a gas being a heated gas to the image formation surface, and a contact heating unit configured to heat the printing medium by coming into contact with a surface on a side opposite to the image formation surface of the printing medium, the printing apparatus including a first mode and a second mode as printing modes for forming the image on the printing medium, the printing method including either setting a temperature of the gas blown by the blower heating unit in the second mode lower than a temperature of the gas blown by the blower heating unit in the first mode or setting a heating temperature of the contact heating unit in the second mode lower than a heating temperature of the contact heating unit in the first mode or both, and setting a wind velocity of the gas blown by the blower heating unit in the second mode higher than a wind velocity of the gas blown by the blower heating unit in the first mode.

### BRIEF DESCRIPTION OF THE DRAWINGS

FIG. 1 is a schematic side view of a printing apparatus according to an example 1 of the present disclosure.

FIG. 2 is a schematic side view of a drying oven of the printing apparatus of FIG. 1.

FIG. 3 is a flowchart illustrating an example of a printing method using the printing apparatus of FIG. 1.

FIG. 4 is a schematic side view of a drying oven of a printing apparatus according to an example 2 of the present disclosure.

### DESCRIPTION OF EMBODIMENTS

First, the present disclosure is schematically described.

A printing apparatus of a first aspect of the present disclosure for solving the above-mentioned problems includes a setting unit at which a printing medium with a roll form is to be set, a winding unit configured to wind up the printing medium conveyed from the setting unit, a printing head configured to form an image by ejecting ink to an image formation surface of the printing medium conveyed, and a drying oven disposed downstream of the printing head in a conveyance path of the printing medium in a conveyance direction of the printing medium, the drying oven being configured to dry the ink ejected to the printing medium. The drying oven includes a heating unit configured to heat the printing medium. The heating unit includes a blower heating unit configured to blow a gas being a heated gas to the image formation surface, and a contact heating unit configured to heat the printing medium by coming into contact with a surface on a side opposite to the image formation surface of the printing medium. The printing apparatus includes a first mode and a second mode as printing modes for forming the image on the printing medium. Either a temperature of the gas blown by the blower heating unit in the second mode is lower than a temperature of the gas blown by the blower heating unit in the first mode or a heating temperature of the contact heating unit in the second mode is lower than a heating temperature of the contact heating unit in the first mode or both. A wind velocity of the gas blown by the blower heating unit in the second mode is higher than a wind velocity of the gas blown by the blower heating unit in the first mode.

According to this aspect, either a temperature of the gas blown by the blower heating unit in the second mode is lower than a temperature of the gas blown by the blower heating unit in the first mode or a heating temperature of the contact heating unit in the second mode is lower than a heating temperature of the contact heating unit in the first mode or both, and a wind velocity of the gas blown by the blower heating unit in the second mode is higher than a wind velocity of the gas blown by the blower heating unit in the first mode. That is, in the second mode, the printing medium is heated with a strong wind velocity while preventing excessive increase in the heating temperature for heating the printing medium. In this manner, for example, when a printing medium with a changeable shape is used, the change in shape of the printing medium due to excessive increase in the heating temperature can be suppressed by selecting the second mode.

A second aspect of the present disclosure is an aspect depending on the first aspect, in which the temperature of the gas blown by the blower heating unit in the second mode is lower than the temperature of the gas blown by the blower heating unit in the first mode, and the heating temperature of the contact heating unit in the second mode is lower than the heating temperature of the contact heating unit in the first mode.

According to this aspect, the temperature of the gas blown by the blower heating unit in the second mode is lower than the temperature of the gas blown by the blower heating unit in the first mode, and the heating temperature of the contact heating unit in the second mode is lower than the heating temperature of the contact heating unit in the first mode. In this manner, for example, when a printing medium with a changeable shape is used, excessive increase in the heating temperature can be especially effectively suppressed, and the change in shape of the printing medium can be especially effectively suppressed by selecting the second mode.

A third aspect of the present disclosure is an aspect depending on the first or second aspect, in which the temperature of the gas blown by the blower heating unit in the second mode is lower than the heating temperature of the contact heating unit in the second mode.

For example, in the case where a printing medium with a changeable shape is used, the shape is easily changed especially when the heating temperature of the image formation surface is excessively increased. However, according to this aspect, the heating temperature of the contact heating unit in the second mode is higher than the temperature of the gas blown by the blower heating unit in the second mode. In view of this, when a printing medium with a changeable shape is used, excessive increase in the heating temperature of the image formation surface can be especially effectively suppressed, and the change in shape of the printing medium can be especially effectively suppressed.

A fourth aspect of the present disclosure is an aspect depending on the first or second aspect and further includes an input unit from which information about a type of the printing medium to be used is input, and a printing mode setting unit configured to set the printing mode in accordance with the information input from the input unit, in which the printing mode setting unit sets the printing mode to the second mode when a material of the image formation surface of the printing medium to be used is a film and a material of a surface opposite to the image formation surface is paper.

The shape of the printing medium of which the material of the image formation surface is a film and the material of the surface opposite to the image formation surface is paper is especially changeable; however, according to this aspect, the printing mode can be automatically set to the second mode in accordance with the information input to the input unit when using the printing medium of which the material of the image formation surface is a film and the material of the surface opposite to the image formation surface is paper. In this manner, when using the printing medium of which the material of the image formation surface is a film and the material of the surface opposite to the image formation surface is paper, the risk of errors in printing mode selection can be reduced, and the change in shape of the printing medium can be easily suppressed.

A printing apparatus of a fifth aspect of the present disclosure includes a setting unit at which a printing medium with a roll form is to be set, a winding unit configured to wind up the printing medium conveyed from the setting unit, a printing head configured to form an image by ejecting ink to an image formation surface of the printing medium conveyed, and a drying oven disposed downstream of the printing head in a conveyance path of the printing medium in a conveyance direction of the printing medium, the drying oven being configured to dry the ink ejected to the printing medium. The drying oven includes a heating unit configured to heat the printing medium. The heating unit includes a blower heating unit configured to blow a gas being a heated gas to the image formation surface, and a contact heating unit configured to heat the printing medium by coming into contact with a surface on a side opposite to the image formation surface of the printing medium. The contact heating unit includes a first contact heating unit, and a second contact heating unit disposed downstream of the first contact heating unit in the conveyance direction. The blower heating unit includes a first blower heating unit, and a second blower heating unit disposed downstream of the first blower heating unit in the conveyance direction. The printing apparatus includes a first mode and a second mode as printing modes for forming the image on the printing medium. A heating temperature of the first contact heating unit in the second mode is lower than a heating temperature of the first contact heating unit in the first mode. A heating temperature of the second contact heating unit in the second mode is lower than a heating temperature of the second contact heating unit in the first mode. A temperature of the gas blown by the first blower heating unit in the second mode is lower than a temperature of the gas blown by the first blower heating unit in the first mode. A temperature of the gas blown by the second blower heating unit in the second mode is lower than a temperature of the gas blown by the second blower heating unit in the first mode. A wind velocity of the gas blown by the first blower heating unit in the second mode is higher than a wind velocity of the gas blown by the first blower heating unit in the first mode. A wind velocity of the gas blown by the second blower heating unit in the second mode is higher than a wind velocity of the gas blown by the second blower heating unit in the first mode.

According to this aspect, a heating temperature of the first contact heating unit in the second mode is lower than a heating temperature of the first contact heating unit in the first mode, a heating temperature of the second contact heating unit in the second mode is lower than a heating temperature of the second contact heating unit in the first mode, a temperature of the gas blown by the first blower heating unit in the second mode is lower than a temperature of the gas blown by the first blower heating unit in the first mode, a temperature of the gas blown by the second blower heating unit in the second mode is lower than a temperature of the gas blown by the second blower heating unit in the first mode, a wind velocity of the gas blown by the first blower heating unit in the second mode is higher than a wind velocity of the gas blown by the first blower heating unit in the first mode, and a wind velocity of the gas blown by the second blower heating unit in the second mode is higher than a wind velocity of the gas blown by the second blower heating unit in the first mode. That is, in the second mode, the printing medium is heated with a strong wind velocity while preventing excessive increase in the heating temperature for heating the printing medium. In this manner, for example, when a printing medium with a changeable shape is used, the change in shape of the printing medium due to excessive increase in the heating temperature can be suppressed by selecting the second mode.

A printing method of a sixth aspect of the present disclosure is a printing method for a printing apparatus, the printing apparatus including a setting unit at which a printing medium with a roll form is to be set, a winding unit configured to wind up the printing medium conveyed from the setting unit, a printing head configured to form an image by ejecting ink to an image formation surface of the printing medium conveyed, and a drying oven disposed downstream of the printing head in a conveyance path of the printing medium in a conveyance direction of the printing medium, the drying oven being configured to dry the ink ejected to the printing medium, the drying oven including a heating unit configured to heat the printing medium, the heating unit including a blower heating unit configured to blow a gas being a heated gas to the image formation surface, and a contact heating unit configured to heat the printing medium by coming into contact with a surface on a side opposite to the image formation surface of the printing medium, the printing apparatus including a first mode and a second mode as printing modes for forming the image on the printing medium. The printing method includes either setting a temperature of the gas blown by the blower heating unit in the second mode lower than a temperature of the gas blown by the blower heating unit in the first mode or setting a heating temperature of the contact heating unit in the second mode lower than a heating temperature of the contact heating unit in the first mode or both, and setting a wind velocity of the gas blown by the blower heating unit in the second mode higher than a wind velocity of the gas blown by the blower heating unit in the first mode.

According to this aspect, either a temperature of the gas blown by the blower heating unit in the second mode is lower than a temperature of the gas blown by the blower heating unit in the first mode or a heating temperature of the contact heating unit in the second mode is lower than a heating temperature of the contact heating unit in the first mode or both, and a wind velocity of the gas blown by the blower heating unit in the second mode is higher than a wind velocity of the gas blown by the blower heating unit in the first mode. That is, in the second mode, the printing medium is heated with a strong wind velocity while preventing excessive increase in the heating temperature for heating the printing medium. In this manner, for example, when a printing medium with a changeable shape is used, the change in shape of the printing medium due to excessive increase in the heating temperature can be suppressed by selecting the second mode.

A printing method of a seventh aspect of the present disclosure is a printing method for a printing apparatus, the printing apparatus including a setting unit at which a printing medium with a roll form is to be set, a winding unit configured to wind up the printing medium conveyed from the setting unit, a printing head configured to form an image by ejecting ink to an image formation surface of the printing medium conveyed, and a drying oven disposed downstream of the printing head in a conveyance path of the printing medium in a conveyance direction of the printing medium, the drying oven being configured to dry the ink ejected to the printing medium, the drying oven including a heating unit configured to heat the printing medium, the heating unit including a blower heating unit configured to blow a gas being a heated gas to the image formation surface, and a contact heating unit configured to heat the printing medium by coming into contact with a surface on a side opposite to the image formation surface of the printing medium, the contact heating unit including a first contact heating unit, and a second contact heating unit disposed downstream of the first contact heating unit in the conveyance direction, the blower heating unit including a first blower heating unit, and a second blower heating unit disposed downstream of the first blower heating unit in the conveyance direction, the printing apparatus including a first mode and a second mode as printing modes for forming the image on the printing medium. The printing method includes setting a heating temperature of the first contact heating unit in the second mode lower than a heating temperature of the first contact heating unit in the first mode, setting a heating temperature of the second contact heating unit in the second mode lower than a heating temperature of the second contact heating unit in the first mode, setting a temperature of the gas blown by the first blower heating unit in the second mode lower than a temperature of the gas blown by the first blower heating unit in the first mode, setting a temperature of the gas blown by the second blower heating unit in the second mode lower than a temperature of the gas blown by the second blower heating unit in the first mode, setting a wind velocity of the gas blown by the first blower heating unit in the second mode higher than a wind velocity of the gas blown by the first blower heating unit in the first mode, and setting a wind velocity of the gas blown by the second blower heating unit in the second mode higher than a wind velocity of the gas blown by the second blower heating unit in the first mode.

According to this aspect, a heating temperature of the first contact heating unit in the second mode is lower than a heating temperature of the first contact heating unit in the first mode, a heating temperature of the second contact heating unit in the second mode is lower than a heating temperature of the second contact heating unit in the first mode, a temperature of the gas blown by the first blower heating unit in the second mode is lower than a temperature of the gas blown by the first blower heating unit in the first mode, a temperature of the gas blown by the second blower heating unit in the second mode is lower than a temperature of the gas blown by the second blower heating unit in the first mode, a wind velocity of the gas blown by the first blower heating unit in the second mode is higher than a wind velocity of the gas blown by the first blower heating unit in the first mode, and a wind velocity of the gas blown by the second blower heating unit in the second mode is higher than a wind velocity of the gas blown by the second blower heating unit in the first mode. That is, in the second mode, the printing medium is heated with a strong wind velocity while preventing excessive increase in the heating temperature for heating the printing medium. In this manner, for example, when a printing medium with a changeable shape is used, the change in shape of the printing medium due to excessive increase in the heating temperature can be suppressed by selecting the second mode.

### Example 1

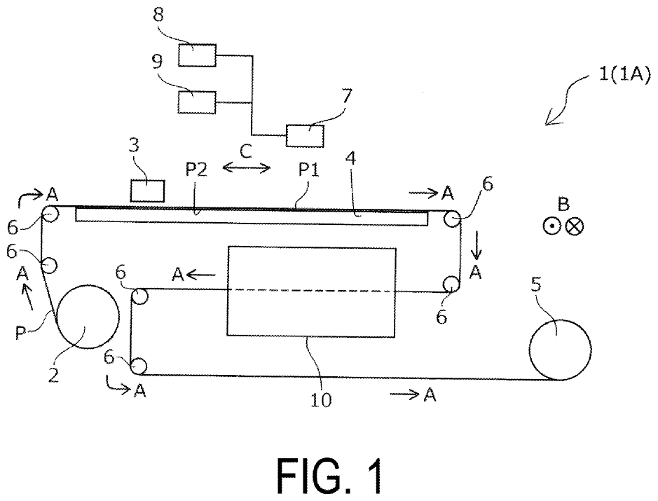

Embodiments according to the present disclosure are described in detail below with reference to the accompanying drawings. First, an overview of a printing apparatus 1A of an example 1 as an example of a printing apparatus 1 of the present disclosure is described with reference to FIG. 1. As illustrated in FIG. 1, the printing apparatus 1A of this example includes a setting unit 2 at which a printing medium P in a roll form is to be set, winding unit 5 that winds up the printing medium P conveyed from the setting unit 2, and a printing head 3 that forms an image by blowing ink to an image formation surface P1 of the printing medium P conveyed in a conveyance direction A in the conveyance path from the setting unit 2 to a winding unit 5. In addition, it includes a platen 4 that supports the printing medium P in the image formation region where images are formed by the printing head 3, and a plurality of conveyance rollers 6 provided in the conveyance path of the printing medium P as a conveyance unit of the printing medium P. Further, the printing apparatus 1A of this example includes a control unit 7 including a CPU, a storage unit and the like, and each component of the printing apparatus 1A of this example is driven under the control of the control unit 7.

The printing head 3 is provided on the side facing the image formation surface P1 of the printing medium P conveyed in the conveyance direction A, and the printing head 3 forms an image by ejecting ink onto the image formation surface P1 in the state where an opposite surface P2 on the side opposite to the image formation surface P1 of the printing medium P is supported by the platen 4. Specifically, the printing apparatus 1A of this example performs printing by moving the printing head 3 back and forth in a scanning direction C along the conveyance direction A. More specifically, the printing apparatus 1A of this example intermittently drives (intermittently conveys) the printing medium P in the conveyance direction A, and moves the printing head 3 back and forth in the scanning direction C to perform printing by ejecting ink from the printing head 3.

Note that the printing head 3 of this example can complete the image formation of the entire image formation region supported by the platen 4 in the image formation surface P1 through a single scan (single pass), and can complete the image formation of the entire image formation region by performing the scanning multiple times (a plurality of passes). When the image formation is completed by a plurality of passes, the conveyance stop time of the printing medium P due to the intermittent conveyance is naturally longer than when the image formation is completed by a single pass.

As described above, the printing head 3 of this example is configured to perform printing by moving back and forth in the scanning direction C along the conveyance direction A. It should be noted that the configuration of the printing head 3 is not particularly limited. In place of the printing head 3 that performs printing by moving back and forth in the scanning direction C along the conveyance direction A, the printing head 3 may be included that performs printing by moving back and forth in a width direction B intersecting the conveyance direction A, or a so-called line head may be included that performs printing in the state where the printing head is stopped with nozzles provided side by side along the width direction B and configured to eject ink over the entirety of the width direction B of the printing medium P.

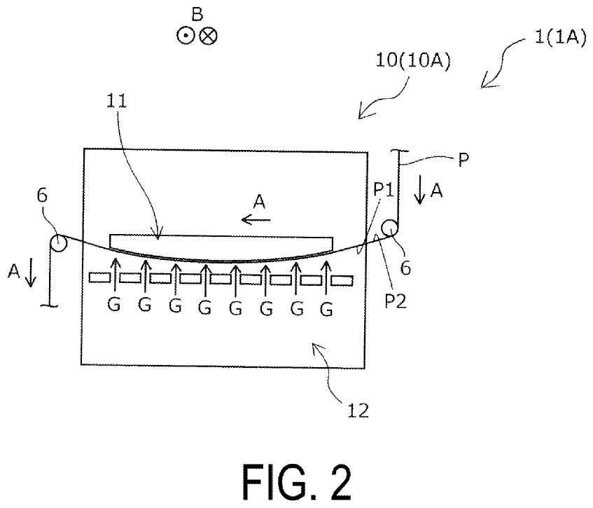

In addition, as illustrated in FIG. 1, a drying oven 10A as a drying oven 10 that dries the ink ejected to the printing medium P is provided at a position downstream of the printing head 3 in the conveyance direction A in the conveyance path of the printing medium P. In view of this, the drying oven 10A of the printing apparatus 1A of this example is specifically described below with reference to FIG. 2.

As illustrated in FIG. 2, the drying oven 10A of the printing apparatus 1A of this example includes, as the heating unit that heats the printing medium P, a contact heating unit 11, which is a contact type heater that heats the printing medium P by coming into contact with the opposite surface P2 of the printing medium P, and a blower heating unit 12 that blows a gas G to the image formation surface P1, the gas G being a heated gas. In this manner, with the two types of heating units, the printing apparatus 1A of this example is configured to efficiently dry the ink ejected to the printing medium P.

Here, the printing apparatus 1A of this example is configured to use various types of the printing medium P. Further, the printing apparatus 1A is configured such that the printing mode for forming images on the printing medium P can be changed in accordance with the type of the printing medium P to be used. More specifically, the printing apparatus 1A of this example includes a first mode and a second mode as printing modes. When the user selects the type of the printing medium P to be used through the user interface of a PC 9, an operation panel 8 provided in the printing apparatus 1A and the like, the information is input to the control unit 7, and the control unit 7 sets the printing mode to one of the first mode and the second mode.

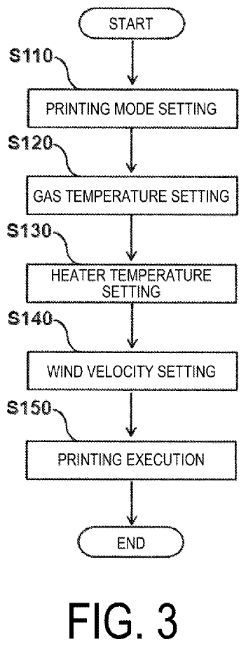

An example of a printing method performed by using the printing apparatus 1A of this example including specific examples of the setting of the printing mode is described below with reference to a flowchart of FIG. 3. Note that as described above, the printing apparatus 1A of this example includes the setting unit 2 at which the printing medium P in a roll form is to be set, the winding unit 5 that winds up the printing medium P conveyed from the setting unit 2, the printing head 3 that forms an image by ejecting ink to the image formation surface P1 of the printing medium P conveyed, and the drying oven 10 disposed at a position downstream of the printing head 3 in the conveyance direction A in the conveyance path of the printing medium P, the drying oven 10 being configured to dry the ink ejected to the printing medium P. In addition, the drying oven 10 of the printing apparatus 1A of this example includes, as the heating unit that heats the printing medium P, the blower heating unit 12 that blows the gas G being a heated gas to the image formation surface P1, and the contact heating unit 11 that heats the printing medium P by coming into contact with the opposite surface P2 of the printing medium P. A fan that can blow hot air may be used as the blower heating unit 12, for example. A metal plate where a nichrome wire or the like is disposed may be used as the contact heating unit 11, for example. Further, the printing apparatus 1A of this example includes the first mode and the second mode as printing modes for forming an image on the printing medium P. The printing method described below is a printing method that can be executed by the printing apparatus with the above-described configuration.

When starting the printing, first, the user selects the printing medium P to be used through the PC 9, the operation panel 8 provided in the printing apparatus 1A and the like in the printing mode setting of step S110. Note that the printing apparatus 1A of this example can use various printing mediums P such as the printing medium P of which the image formation surface P1 and the opposite surface P2 are both paper, the printing medium P of which the image formation surface P1 and the opposite surface P2 are both films, the printing medium P of which the image formation surface P1 is a film and the opposite surface P2 is paper, and the printing medium P of which the image formation surface P1 is paper and the opposite surface P2 is a film, for example. In accordance with the selection of the printing medium P by the user, the control unit 7 sets the printing mode to the first mode or the second mode. Here, in the printing method of this example, when the printing medium P of which the image formation surface P1 and the opposite surface P2 are both paper, or the printing medium P of which the image formation surface P1 and the opposite surface P2 are both films are selected by the operator, the printing mode is set to the first mode by the control unit 7. On the other hand, when the printing medium P of which the image formation surface P1 is a film and the opposite surface P2 is paper, or the printing medium P of which the image formation surface P1 is paper and the opposite surface P2 is a film is selected by the operator, the printing mode is set to the second mode by the control unit 7.

Next, in the gas temperature setting of step S120, the temperature of the gas G to be blown by the blower heating unit 12 is set. Here, in the printing method of this example, when the printing mode is set to the first mode in the printing mode setting of step S110, the temperature of the gas G to be blown by the blower heating unit 12 is set to 75° C. On the other hand, when the printing mode is set to the second mode in the printing mode setting of step S110, the temperature of the gas G to be blown by the blower heating unit 12 is set to 55° C.

Next, in the heater temperature setting of step S130, the temperature of the heater provided in the contact heating unit 11 is set. Here, in the printing method of this example, when the printing mode is set to the first mode in the printing mode setting f step S110, the temperature of the heater is set to 75° C. On the other hand, when the printing mode is set to the second mode in the printing mode setting of step S110, the temperature of the heater is set to 70° C.

Next, in the wind velocity setting of step S140, the wind velocity of the gas G to be blown by the blower heating unit 12 is set. Here, in the printing method of this example, when the printing mode is set to the first mode in the printing mode setting of step S110, the wind velocity of the gas G to be blown by the blower heating unit 12 is set to 10 m/s. On the other hand, when the printing mode is set to the second mode in the printing mode setting of step S110, the temperature of the gas G to be blown by the blower heating unit 12 is set to 20 m/s.

Here, the gas temperature setting of step S120, the heater temperature setting of step S130, and the wind velocity setting of step S140 of FIG. 3 need not be performed in the order in the flowchart. The steps may be performed in different orders, and at least two of the steps may be simultaneously performed. Note that each item set in the gas temperature setting of step S120, the heater temperature setting of step S130, and the wind velocity setting of step S140 in this example can be listed as in the following Table 1.

TABLE 1

| | Gas | Heater | Wind |
|---|---|---|---|
| | temperature | temperature | velocity |
| Printing mode | (° C.) | (° C.) | (m/s) |
| First mode | 75 | 75 | 10 |
| Second mode | 70 | 55 | 20 |

Next, in the printing execution of step S150, the printing medium P is conveyed in the conveyance direction A and the ink is ejected from the printing head 3 to form a desired image on the image formation surface P1. Then, upon completion of the formation of the desired image on the image formation surface P1, the printing method of this example is completed.

As in the printing method of this example, either the temperature of the gas G blown by the blower heating unit 12 in the second mode may be lower than the temperature of the gas G blown by the blower heating unit 12 in the first mode or the heating temperature of the contact heating unit 11 in the second mode may be lower than the heating temperature of the contact heating unit 11 in the first mode or both, and the wind velocity of the gas G blown by the blower heating unit 12 in the second mode may be greater than the wind velocity of the gas G blown by the blower heating unit 12 in the first mode. The reason for this is that under such a drying condition of the printing medium P, the printing medium P can be heated with a strong wind velocity while preventing excessive increase in the heating temperature for heating the printing medium P in the second mode. Further, for example, when the printing medium P with a changeable shape is used, the change in shape of the printing medium P due to excessive increase in the heating temperature can be suppressed by selecting the second mode.

In particular, the temperature of the gas G blown by the blower heating unit 12 in the second mode may be lower than the temperature of the gas G blown by the blower heating unit 12 in the first mode, and the heating temperature of the contact heating unit 11 in the second mode may be lower than the heating temperature of the contact heating unit 11 in the first mode as in the printing method of this example. The reason for this is that when the printing medium P with a changeable shape is used, excessive increase in the heating temperature can be especially effectively suppressed and the change in shape of the printing medium P can be especially effectively suppressed by selecting the second mode, for example. It should be noted that such a configuration is not limitative. In Table 1, for example, a configuration may be adopted in which only one of a setting in which the heating temperature of the contact heating unit 11 in the second mode (heater temperature) is set to 75° C. or a setting in which the temperature of the gas G blown by the blower heating unit 12 in the second mode (gas temperature) is set to 75° C. is modified.

For example, in the case where the printing medium P with a changeable shape is used, the shape is especially changed when the heating temperature of the image formation surface P1 is excessively increased. In the printing method of this example, however, as shown in Table 1, the heating temperature of the contact heating unit 11 in the second mode is 70° ° C., and the temperature of the gas G blown by the blower heating unit 12 in the second mode is 55° C., and the temperature of the gas G blown by the blower heating unit 12 in the second mode is lower than the heating temperature of the contact heating unit 11 in the second mode. In this manner, in the printing method of this example, when the printing medium P with a changeable shape is used, excessive increase in the heating temperature of the image formation surface P1 can be especially effectively suppressed, and the change in shape of the printing medium P can be especially effectively suppressed.

In addition, as described above, the printing apparatus 1A of this example includes the control unit 7, and the control unit 7 plays a role of a printing mode setting unit that inputs information about the type of the printing medium P to be used through the PC 9 or the operation panel 8 serving as the input unit and sets the printing mode in accordance with the information input from the input unit. Further, as described above, when the material of the image formation surface P1 of the printing medium P to be used is a film and the material of the opposite surface P2 is paper, the control unit 7 serving as the printing mode setting unit sets the printing mode to the second mode in the printing mode setting of step S110.

The shape of the printing medium P of which the material of the image formation surface P1 is a film and the material of the opposite surface P2 is paper is especially changeable, but when using the printing medium P of which the material the image formation surface P1 is a film and the material of the opposite surface P2 is paper, the printing apparatus 1A of this example can automatically set the printing mode to the second mode in accordance with the information about the material of that printing medium P input from the input unit. In this manner, when using the printing medium P of which the material of the image formation surface P1 is a film and the material of the opposite surface P2 is paper, the printing apparatus 1A of this example can easily reduce the risk of errors in printing mode selection, and suppress the change in shape of the printing medium P.

Note that when the materials of the image formation surface P1 and the opposite surface P2 are of the same type, such as when they are both films or paper, the shape of the printing medium P is less changeable. Therefore, when the materials of the image formation surface P1 and the opposite surface P2 are of the same type, the printing apparatus 1A of this example can automatically set the printing mode to the first mode in accordance with the information about the material of that printing medium P input from the input unit as described above.

### Example 2

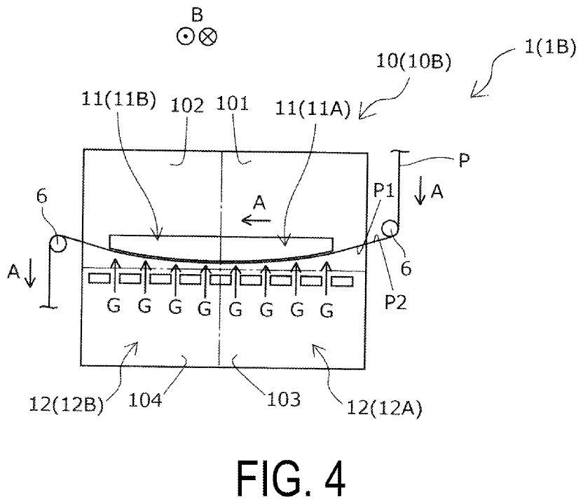

Next, a printing apparatus 1B of an example 2 is described with reference to FIG. 4. Note that FIG. 4 corresponds to FIG. 2 for the printing apparatus 1 of the example 1. The components common to the example 1 in FIG. 4 are denoted with the same reference numerals, and the description thereof is omitted. Here, the printing apparatus 1B of this example has the same configuration as that of the printing apparatus 1A of the example 1 except for the configuration of the drying oven 10. Therefore, the printing apparatus 1B of this example has the same features as those of the printing apparatus 1A of the example 1 except for the portions other than the portions described below.

As illustrated in FIG. 4, the printing apparatus 1B of this example includes, as the drying oven 10, a drying oven 10B that can be segmented into a first region 101, a second region 102, a third region 103 and a fourth region 104. Then, the contact heating unit 11 is disposed across the first region 101 and the second region 102, and the blower heating unit 12 is disposed across the third region 103 and the fourth region 104. Here, the contact heating unit 11 can heat the printing medium P at different heating temperatures for the first region 101 and the second region 102, and the blower heating unit 12 can blow the gas G to the printing medium P at different temperatures and different air velocities for the third region 103 and the fourth region 104.

In other words, the contact heating unit 11 includes a first contact heating unit 11A that heats the printing medium P in the first region 101, and a second contact heating unit 11B that heats the printing medium P in the second region 102 disposed downstream of the first region 101 where the first contact heating unit 11A is disposed, in the conveyance direction A. Further, the blower heating unit 12 includes a first blower heating unit 12A that blows the gas G to the printing medium P in the third region 103, and a second blower heating unit 12B that blows the gas G to the printing medium P in the fourth region 104 disposed downstream of the third region 103 where the first blower heating unit is disposed, in the conveyance direction A.

In addition, the printing apparatus 1B of this example includes the first mode and the second mode as printing modes as with the printing apparatus 1 of the example 1, and can execute the printing method under the condition described below in accordance with the procedure illustrated in the flowchart of FIG. 3. In the procedure, the heating temperature of the first contact heating unit 11A in the second mode is set to a temperature lower than the heating temperature of the first contact heating unit 11A in the first mode, and the heating temperature of the second contact heating unit 11B in the second mode is set to a temperature lower than the heating temperature of the second contact heating unit 11B in the first mode. Further, the temperature of the gas G blown by the first blower heating unit 12A in the second mode is set to a temperature lower than the temperature of the gas G blown by the first blower heating unit 12A in the first mode, and the temperature of the gas blown by the second blower heating unit 12B in the second mode is set to a temperature lower than the temperature of the gas G blown by the second blower heating unit 12B in the first mode. Further, the wind velocity of the gas G blown by the first blower heating unit 12A in the second mode is set higher than the wind velocity of the gas G blown by the first blower heating unit 12A in the first mode, and the wind velocity of the gas G blown by the second blower heating unit 12B in the second mode is set higher than the wind velocity of the gas G blown by the second blower heating unit 12B in the first mode.

That is, as with the printing apparatus 1A of the example 1, the printing apparatus 1B of this example can heat the printing medium P with a strong wind velocity while preventing excessive increase in the heating temperature for heating the printing medium P in the second mode. In this manner, as with the printing apparatus 1A of the example 1, the printing apparatus 1B of this example can suppress the change in shape of the printing medium P due to excessive increase in the heating temperature by selecting the second mode when the printing medium P with a changeable shape is used, for example. Note that for the printing method using the printing apparatus 1B of this example, the following Table 2 shows, as preferable examples, the conditions of the items that can be set in the gas temperature setting of step S120, the heater temperature setting of step S130, and the wind velocity setting of step S140 in the flowchart of FIG. 3. The condition for determining which of the first mode and the second mode is to be set based on the type of the printing medium P may be the same as that of the printing apparatus 1A of the example 1, for example.

TABLE 2

| | Gas | | Heater | | Wind | |
|---|---|---|---|---|---|---|
| | temperature (° C.) | | temperature (° C.) | | velocity (m/s) | |
| Printing | Third | Fourth | First | Second | Third | Fourth |
| mode | region | region | region | region | region | region |
| First mode | 75 | 75 | 75 | 75 | 10 | 10 |
| Second mode | 60 | 65 | 65 | 70 | 20 | 20 |

Note that as is clear from Table 2, in the second mode, the printing apparatus 1B of this example sets the gas temperature and the heater temperature in the first region 101 and the third region 103 upstream in the conveyance direction A to temperatures lower than in the second region 102 and the fourth region 104 downstream in the conveyance direction A. The reason for this is as follows. If the printing medium P is heated at a high temperature immediately after being put in the drying oven 10, the deformation of the printing medium P is undesirably significant due to the large difference between the temperature of the outside of the drying oven 10 and the temperature of the inside of the drying oven 10. In view of this, the deformation of the printing medium P is suppressed to a small level by reducing the temperature difference from the outside of the drying oven 10 by performing the heating at a low temperature in the upstream of the drying oven 10, while ensuring the drying speed by performing the heating at a high temperature in the downstream of the drying oven 10 to compensate for the insufficient heat value due to the low-temperature heating in the upstream.

The present disclosure is not limited to the above-described examples, and can be realized in various configurations without departing from the spirit of the present disclosure. For example, in order to solve the problem described above in whole or in part, or in order to achieve the effects described above in whole or in part, the technical characteristics in the examples that correspond to the technical characteristics in each mode described in the outline of the disclosure can be replaced or combined as necessary. Further, when the technical characteristics are not described as being essential in the present specification, the technical characteristics can be deleted as appropriate.

What is claimed is:

1. A printing apparatus comprising:
a setting unit at which a printing medium with a roll form is to be set;
a winding unit configured to wind up the printing medium conveyed from the setting unit;
a printing head configured to form an image by ejecting ink to an image formation surface of the printing medium conveyed; and
a drying oven disposed downstream of the printing head in a conveyance path of the printing medium in a conveyance direction of the printing medium, the drying oven being configured to dry the ink ejected to the printing medium, wherein
the drying oven includes a heating unit configured to heat the printing medium,
the heating unit includes:
a blower heating unit configured to blow a gas being a heated gas to the image formation surface and
a contact heating unit configured to heat the printing medium by coming into contact with a surface on a side opposite to the image formation surface of the printing medium,
the printing apparatus includes a first mode and a second mode as printing modes for forming the image on the printing medium,
either a temperature of the gas blown by the blower heating unit in the second mode is lower than a temperature of the gas blown by the blower heating unit in the first mode or a heating temperature of the contact heating unit in the second mode is lower than a heating temperature of the contact heating unit in the first mode or both, and
a wind velocity of the gas blown by the blower heating unit in the second mode is higher than a wind velocity of the gas blown by the blower heating unit in the first mode.

2. The printing apparatus according to claim 1, wherein
the temperature of the gas blown by the blower heating unit in the second mode is lower than the temperature of the gas blown by the blower heating unit in the first mode and
the heating temperature of the contact heating unit in the second mode is lower than the heating temperature of the contact heating unit in the first mode.

3. The printing apparatus according to claim 1, wherein the temperature of the gas blown by the blower heating unit in the second mode is lower than the heating temperature of the contact heating unit in the second mode.

4. The printing apparatus according to claim 1, further comprising:
an input unit from which information about a type of the printing medium to be used is input; and
a printing mode setting unit configured to set the printing mode in accordance with the information input from the input unit, wherein
the printing mode setting unit sets the printing mode to the second mode when a material of the image formation surface of the printing medium to be used is a film and a material of a surface opposite to the image formation surface is paper.

5. A printing apparatus comprising:
a setting unit at which a printing medium with a roll form is to be set;
a winding unit configured to wind up the printing medium conveyed from the setting unit;
a printing head configured to form an image by ejecting ink to an image formation surface of the printing medium conveyed; and
a drying oven disposed downstream of the printing head in a conveyance path of the printing medium in a conveyance direction of the printing medium, the drying oven being configured to dry the ink ejected to the printing medium, wherein
the drying oven includes a heating unit configured to heat the printing medium,
the heating unit includes:
a blower heating unit configured to blow a gas being a heated gas to the image formation surface and
a contact heating unit configured to heat the printing medium by coming into contact with a surface on a side opposite to the image formation surface of the printing medium,
the contact heating unit includes:
a first contact heating unit and
a second contact heating unit disposed downstream of the first contact heating unit in the conveyance direction,
the blower heating unit includes:
a first blower heating unit and
a second blower heating unit disposed downstream of the first blower heating unit in the conveyance direction,
the printing apparatus includes a first mode and a second mode as printing modes for forming the image on the printing medium,
a heating temperature of the first contact heating unit in the second mode is lower than a heating temperature of the first contact heating unit in the first mode,
a heating temperature of the second contact heating unit in the second mode is lower than a heating temperature of the second contact heating unit in the first mode,
a temperature of the gas blown by the first blower heating unit in the second mode is lower than a temperature of the gas blown by the first blower heating unit in the first mode,
a temperature of the gas blown by the second blower heating unit in the second mode is lower than a temperature of the gas blown by the second blower heating unit in the first mode,
a wind velocity of the gas blown by the first blower heating unit in the second mode is higher than a wind velocity of the gas blown by the first blower heating unit in the first mode, and
a wind velocity of the gas blown by the second blower heating unit in the second mode is higher than a wind velocity of the gas blown by the second blower heating unit in the first mode.

6. A printing method for a printing apparatus, the printing apparatus including:
a setting unit at which a printing medium with a roll form is to be set,
a winding unit configured to wind up the printing medium conveyed from the setting unit,
a printing head configured to form an image by ejecting ink to an image formation surface of the printing medium conveyed, and
a drying oven disposed downstream of the printing head in a conveyance path of the printing medium in a conveyance direction of the printing medium, the drying oven being configured to dry the ink ejected to the printing medium,
the drying oven including a heating unit configured to heat the printing medium,
the heating unit including:
a blower heating unit configured to blow a gas being a heated gas to the image formation surface and
a contact heating unit configured to heat the printing medium by coming into contact with a surface on a side opposite to the image formation surface of the printing medium,
the printing apparatus including a first mode and a second mode as printing modes for forming the image on the printing medium, the printing method comprising:
either setting a temperature of the gas blown by the blower heating unit in the second mode lower than a temperature of the gas blown by the blower heating unit in the first mode or setting a heating temperature of the contact heating unit in the second mode lower than a heating temperature of the contact heating unit in the first mode or both; and
setting a wind velocity of the gas blown by the blower heating unit in the second mode higher than a wind velocity of the gas blown by the blower heating unit in the first mode.
